(19) United States
(12) Patent Application Publication
(10) Pub. No.: US 2026/0203928 A1
(43) Pub. Date: Jul. 16, 2026

(54) SIDE-TO-TOP IMAGE MAPPING FOR RAPID DEPLOYMENT OF UAS GROUND ASSETS

(71) Applicant: Wing Aviation LLC, Palo Alto, CA (US)

(72) Inventors: DOMITILLE COMMUN, Washington, DC (US); JEREMIE GABOR, Mountain View, CA (US); DINUKA ABEYWARDENA, Mountain View, CA (US)

(21) Appl. No.: 19/025,388

(22) Filed: Jan. 16, 2025

(51) Int. Cl. G06T 7/70; G06T 17/00; G06V 10/764; G06V 10/774; G06V 20/17; G08G 5/30; H04W 4/029

(52) U.S. Cl. CPC G06T 7/70; G06T 17/00; G06V 10/764; G06V 10/774; G06V 20/17; G08G 5/30; H04W 4/029; G06T 2207/10032

(57) ABSTRACT

A technique for mapping assets deployed for an unmanned aerial vehicle (UAV) service includes capturing, with a mobile computing device, a plurality of side view images of a ground area including the assets, the assets deployed to the ground area for supporting operations of the UAV service, the side view images acquired from different pedestrian vantage points about the ground area; measuring, by the mobile computing device, camera locations of the mobile computing device when capturing the side view images; analyzing the side view images along with the camera locations of the mobile computing device to determine asset locations of the assets at the ground area; and updating a backend management system of the UAV service to record the asset locations determined from the analyzing.

### TECHNICAL FIELD

This disclosure relates generally to unmanned aircraft systems, and in particular but not exclusively, relates to mapping deployed assets of an unmanned aerial vehicle (UAV) service.

### BACKGROUND INFORMATION

An unmanned vehicle, which may also be referred to as an autonomous vehicle, is a vehicle capable of traveling without a physically present human operator. Various types of unmanned vehicles exist for various different environments. For instance, unmanned vehicles exist for operation in the air, on the ground, underwater, and in space. Unmanned vehicles also exist for hybrid operations in which multi-environment operation is possible. Unmanned vehicles may be provisioned to perform various missions, including payload delivery, exploration/reconnaissance, imaging, public safety, surveillance, or otherwise. The mission definition will often dictate a type of specialized equipment and/or configuration of the unmanned vehicle.

Unmanned aerial vehicles (also referred to as drones) can be adapted for package delivery missions to provide an aerial delivery service. One type of unmanned aerial vehicle (UAV) is a vertical takeoff and landing (VTOL) UAV. VTOL UAVs are particularly well-suited for package delivery missions. The VTOL capability enables a UAV to takeoff and land within a small footprint thereby providing package pick-ups and deliveries almost anywhere.

Since UAVs configured for package delivery missions have a limited delivery range (e.g., 5-20 miles dependent upon package size and weight), a decentralized network of local nests and waypoint package pickup locations may need to be deployed over a region to service merchants and customers. In some situations, the local nests may be temporary nests that are set up and then dismantled after a relatively short period of time. The infrastructure for staging the UAVs and supporting their daily operations at each of these local nests must be physically deployed, mapped, and registered in the backend management systems of the aerial delivery service. Techniques that facilitate efficient and accurate mapping and registration of deployed assets are desirable.

### BRIEF DESCRIPTION OF THE DRAWINGS

Non-limiting and non-exhaustive embodiments of the invention are described with reference to the following figures, wherein like reference numerals refer to like parts throughout the various views unless otherwise specified. Not all instances of an element are necessarily labeled so as not to clutter the drawings where appropriate. The drawings are not necessarily to scale, emphasis instead being placed upon illustrating the principles being described.

FIG. 1 illustrates operation of an unmanned aerial vehicle (UAV) delivery service that delivers packages into a neighborhood, in accordance with an embodiment of the disclosure.

FIG. 2 is a functional block diagram illustrating a system for mapping and registering assets deployed for a UAV service, in accordance with an embodiment of the disclosure.

FIGS. 3A & 3B are a flow chart illustrating a process for mapping and registering assets deployed for a UAV service, in accordance with an embodiment of the disclosure.

FIG. 4A illustrates the process of capturing side view images of the assets deployed to a ground area from different pedestrian vantage points, in accordance with an embodiment of the disclosure.

FIG. 4B illustrates a top view image of the assets at the ground area that is generated based on the side view images, in accordance with an embodiment of the disclosure.

FIG. 5A is a perspective view illustration of a UAV configured for use in a UAV delivery service, in accordance with an embodiment of the disclosure.

FIG. 5B is an underside plan view illustration of the UAV configured for use in the UAV delivery service, in accordance with an embodiment of the disclosure.

### DETAILED DESCRIPTION

Embodiments of a system, apparatus, and method for rapid mapping and registration of assets deployed for use with unmanned aircraft systems (UAS), such as an unmanned aerial vehicle (UAV) delivery service, are described herein. In the following description numerous specific details are set forth to provide a thorough understanding of the embodiments. One skilled in the relevant art will recognize, however, that the techniques described herein can be practiced without one or more of the specific details, or with other methods, components, materials, etc. In other instances, well-known structures, materials, or operations are not shown or described in detail to avoid obscuring certain aspects.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Embodiments described herein facilitate a rapid deployment of assets supporting UAS, such as a UAV delivery service. The assets may include a variety of different ground-based assets/infrastructure including landing pads for staging/charging the UAVs, autoloader mechanisms adapted for transferring packages to the UAVs, fiducial navigation markers (e.g., AprilTags developed by the APRIL robotics lab at the University of Michigan) adapted for visual navigation by the UAVs, or otherwise. These assets may be deployed at local nests, waypoint pickup locations, or otherwise.

When new assets are deployed they must be mapped and registered with a backend management system before a flight mission using one of these assets can be planned. Conventionally, newly deployed assets are mapped using a global navigation satellite system (GNSS) sensor, such as a global positioning system (GPS) stick, which must be manually positioned and read by a field technician who then associates the asset with its location and unique identifier and registers this data with the backend management system. This manual technique is time consuming and prone to human error. Surveying with high precision depends on the availability of skilled surveyors and represents an impediment to rapid and scalable expansion of UAV networks to new locations, is an impediment to establishing temporary nest locations, and may prevent expansion to rural or remote areas that lack the necessary skilled people or equipment. Alternatively, the assets may be mapped via aerial imagery of a ground area where assets have been recently deployed. While aerial imagery at a new nest location may be readily available by sending a UAV straight up to acquire an aerial image and record its GNSS location, this technique is not readily available to waypoint pickup locations that do not stage UAVs. Accordingly, waiting for aerial imagery to map and enroll newly deployed assets can result in added costs and significant delays.

Embodiments disclosed herein use side view images acquired from different pedestrian vantage points about the ground area where new assets are deployed to map their locations for registration with the backend management system. The side view images may be acquired by a field technician with little or no training using a mobile computing device, such as a smartphone with a camera and built-in location sensor (e.g., GPS sensor, inertial measurement sensor (IMU), etc.) that captures ordinary two-dimensional (2D) images and records its current location when capturing each side view image. The mobile computing device may include an application that guides the user through acquiring the various side view images (e.g., four to six images), analyzes the side view images to ensure the assets have been captured from a sufficient number of different vantage points, and even prompts the user when more images are needed. The side view images along with the camera locations associated with each side view image are then analyzed to determine the asset locations of each newly deployed asset. In one embodiment, this analysis is accomplished by generating a three-dimensional (3D) model of the ground area including the new assets by a triangulation from projections of the 2D side view images. In yet another embodiment, the side view images may be used to train a neural radiance field (NeRF) model that generates a top view image of the ground area. The top view image output from the NeRF model may then be geo-registered based on the camera locations of the side view images used to train the NeRF model. These and other aspects of the present invention are described in further detail below.

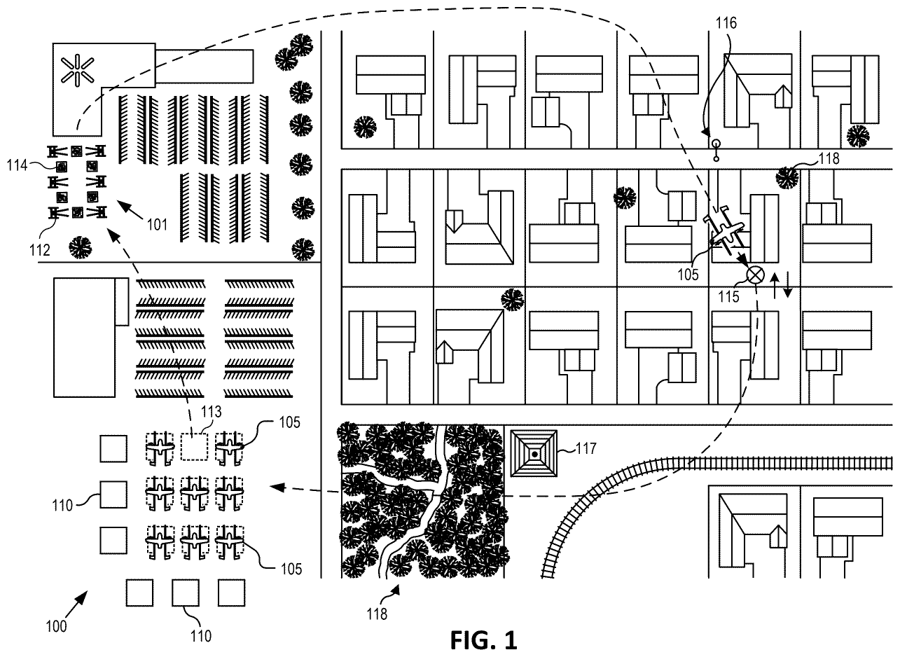

FIG. 1 illustrates operation of a UAV delivery service that delivers packages into a neighborhood, in accordance with an embodiment of the disclosure. UAVs may one day routinely deliver items into urban or suburban neighborhoods from small regional or neighborhood hubs such as terminal area 100 (also referred to as a local nest or staging area). Vendor facilities that wish to take advantage of the aerial delivery service may set up adjacent to terminal area 100 (such as vendor facilities 110) or be dispersed throughout the neighborhood for waypoint package pickups using autoloader mechanisms 112 staged adjacent to the vendor facilities at a waypoint pickup area 101. An example aerial delivery mission may include multiple mission phases such as takeoff from terminal area 100 with a package for delivery to a destination area 115 (also referred to as a delivery zone, drop zone, or delivery destination), rising to a cruising altitude, and cruising to the destination area. Alternatively, the UAV 105 may fly from terminal area 100 to waypoint pickup area 101 for package pickup from an autoloader mechanism 112, before continuing on to destination area 115 for delivery. At destination area 115, UAV 105 descends for package drop-off before once again ascending to a cruise altitude for the return cruise back to terminal area 100.

During the course of a delivery mission, ground-based obstacles are an ever-present hazard—particularly tall slender obstacles such as streetlights 116, telephone poles, radio towers 117, cranes, trees 118, and utility lines. To facilitate an efficient and safe operation of the UAV delivery service, these obstacles must be avoided while assets of the UAV delivery service such as autoloaders, charging/landing pads, and fiducial navigation markers should be reliably detected and accurately tracked. Global navigation satellite systems (GNSS), such as the global positioning system (GPS) in North America, may form a primary localization and navigation subsystem of UAVs 105 for navigating to assets and around obstacles. However, in some situations, the GNSS system may be unavailable or insufficiently accurate. Accordingly, vision-based navigation modules may be used to buttress GNSS by providing fallback localization and/or provide higher precision localization when and where necessary.

In order to plan a new flight mission, such as the delivery mission illustrated in FIG. 1, which uses an asset of the UAV service, the asset should be mapped and registered with the backend management system. For example, if autoloader mechanisms 112 at waypoint pickup area 101 are newly deployed, their locations should be mapped and their unique identifiers registered with their locations in a registry maintained at the backend management system. This registration/enrollment enables the flight planning service to employ the registered asset in its future flight planning.

Conventionally, the mapping and registering of newly deployed assets, such as autoloader mechanism 112, landing pads, fiducial navigation markers, etc., has been a manual process performed by field technicians. Embodiments described herein enable a true map and even a top view image to be quickly obtained, generated, and registered with little to no risk of human error. Conventionally, this information is acquired from satellite imagery, aggregating drone imagery, or manual mapping of the ground area including the newly deployed assets. This is time consuming and error prone. The use of side-to-top mapping enables efficient and accurate mapping and registration of assets immediately after deployment. When a field technician positions a new asset at terminal area 100 or waypoint pickup area 101, a mobile application can prompt the field technician to also acquire side view images and automatically upload them for mapping and registration with the backend management system.

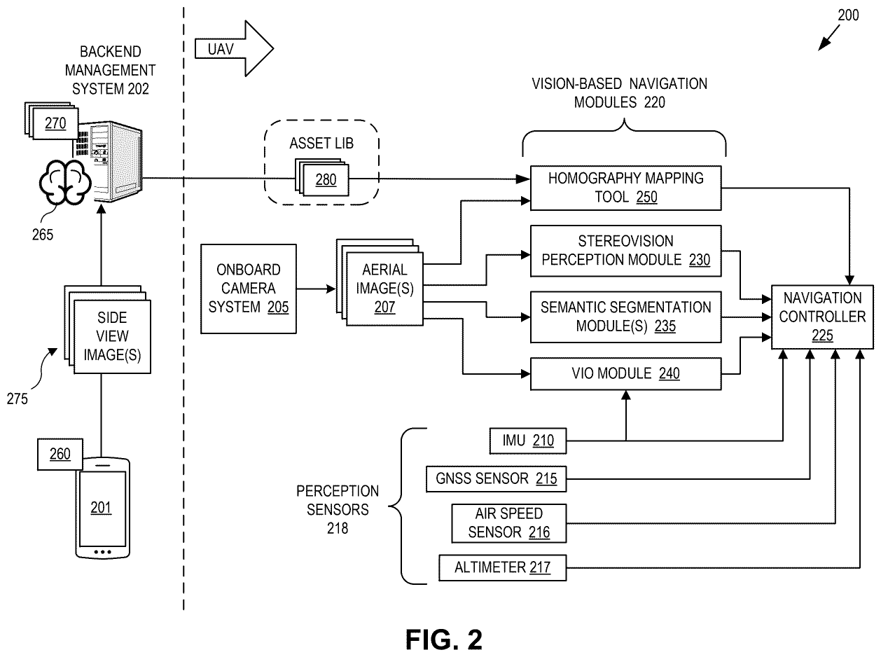

FIG. 2 is a functional block diagram illustrating a system 200 for mapping and registering assets deployed for a UAV service (e.g., UAV delivery service), in accordance with an embodiment of the disclosure. The components of system 200 may also be referred to as unmanned aircraft systems (UAS), which support operations of a UAV service. System 200 includes many of the relevant software and hardware elements for mapping newly deployed assets using a mobile computing device 201 and registering those assets with a backend management system 202, as well as, relevant software and hardware elements disposed onboard UAVs 105 for navigating relative to those newly deployed assets. The components disposed onboard UAVs 105 include an onboard camera system 205 for acquiring aerial images 207, an inertial measurement unit (IMU) 210, a GNSS sensor 215, an air speed sensor 216 (e.g., pitot tube), an altimeter 217 (e.g., air pressure sensor), machine vision modules 220, and a navigation controller 225. Collectively, the sensors 210-217 are referred to as perception sensors 218. The illustrated embodiment of machine vision modules 220 includes a stereovision perception module 230, a semantic segmentation module 235, a visual inertial odometry (VIO) module 240, and a homography mapping tool 250. The components disposed external to UAVs 105 include mobile computing device 201 running an application 260 and a backend management system 202 executing logic 265 for generating assets maps 270 based upon side view images 275 acquired by mobile computing device 201.

Onboard camera system 205 is disposed on UAVs 105 with a downward looking orientation to acquire aerial images 207 of the ground area below it. Aerial images 207 may be acquired at a regular video frame rate (e.g., 20 f/s, 30 f/s, etc.) and a subset of the images provided to the various machine vision modules 220 for analysis. In one embodiment, onboard camera system 205 is a stereovision camera system. While capturing aerial images 207, the camera intrinsics along with sensor readings from the onboard perception sensors 218 may be recorded and indexed to aerial images 207. For example, IMU 210 may include one or more of an accelerometer, a gyroscope, or a magnetometer to capture accelerations (linear or rotational), attitude, and heading readings. GNSS sensor 215 may be a global positioning system (GPS) sensor, or otherwise, and output longitude/latitude position, mean sea level (MSL) altitude, heading, speed over ground (SOG), etc. Air speed sensor 216 captures air speed of UAV 105 while underway, which may serve as a rough approximation for SOG when adjusted for weather conditions. Altimeter 217 measures air pressure, which provides MSL altitude, which may be offset using elevation map data to estimate above ground level (AGL) altitude.

During flight missions, machine vision modules 220 are operated as part of an onboard machine vision system and may constantly receive aerial images 207 and detect, identify, and track objects represented in those aerial images. Stereovision perception module 230 analyzes parallax between stereovision aerial images acquired by onboard camera system 205 to estimate distance to pixels/features/objects in aerial images 207. These stereovision depth estimates may be referred to as a stereovision depth map. VIO module 240 estimates the three-dimensional (3D) pose (e.g., position/orientation) of onboard camera system 205 of UAV 105 using aerial images 207 and IMU 210. In other words, VIO module 204 provides ego-motion tracking relative to the surrounding environment of UAV 105. Semantic segmentation module 235 uses image segmentation to inform object detection and identification (e.g., pixelwise classification) along with feature tracking within aerial images 207. Feature tracking includes the detection and tracking of features within aerial images 207. Features may include edges, corners, high contrast points, etc. of objects within aerial images 207. Recognized objects may be tracked and the classifications provided to other modules responsible for making real-time flight decisions. In one embodiment, specialty instances of semantic segmentation modules 235, referred to as object detection modules, may be trained to perform object detection of objects that are commonly referenced by the aerial delivery service. These object detection modules may include an autoloader detector model having a neural network trained to detect autoloaders 112 of the UAV delivery service, a charge pad detector model having a neural network trained to detect charging/landing pads 113 of the UAV delivery service, a fiducial detector model having a neural network trained to detector fiducial navigation markers 114, or otherwise.

Homography mapping tool 250 is a machine vision tool that matches features or interest points in navigation reference images 280 to their corresponding features or interest points in aerial images 207 acquired in real-time during a flight mission. UAV 105 may be provisioned with relevant navigation reference images 280 along with the rest of their mission data including the flight plan. Navigation reference images 280 may include top view images of specific ground areas with deployed assets annotated for identification. Homography mapping tool 250 performs a pixel-to-pixel mapping between a navigation reference image 280 and a current aerial image 207. Homography mapping tool 250 may be implemented using a variety of tools including a feature extractor that pre-analyzes the images to identify interest points or features in each picture followed by a feature matcher for mapping those identified interest points or features to each other in the images. Features or interest points may include corners, lines, high contrast boundaries, etc. that are distinctly delineated in each of the images. In one embodiment, homography mapping tool 250 may be implemented using SuperPoint and SuperGlue available from Magic Leap, Inc. SuperPoint is a commercially available tool for extracting features from an image while SuperGlue is a commercially available tool for matching those features between two images to generate a homography between the two images.

Navigation reference images 280 may be assembled into an asset library stored within local memory of UAVs 105. The asset library is provisioned with relevant navigation reference images 280 from backend management system 202 prior to flying a mission. The relevant navigation reference images 280 for a given mission may include annotated top view images of relevant ground areas, such as terminal area 100 and/or waypoint pickup area 101, with newly deployed assets. A given navigation reference image 280 may include a top view image of the relevant ground area annotated with labels describing objects/assets depicted in the top view image. The objects/assets may include a variety of ground-based objects, but notably may include various assets of the UAV delivery services such as landing/charging pads 113, autoloaders 112, fiducial navigation markers 114 (e.g., AprilTags), etc. Accordingly, each navigation reference image 280 may include a top view image along with metadata. The metadata may include annotations of objects within the corresponding reference aerial image, descriptors for the objects (e.g., classification, object identifier, geolocation data, etc.), geolocation data for image pixels within the top view images, etc.

Collectively, vision-based navigation modules 220 provide vision-based analysis and understanding of the surrounding environment, which may be used by navigation controller 225 to inform navigation decisions, and perform UAV localization, automated obstacle avoidance, route traversal, etc. Of course, the outputs from machine vision modules 220 may be combined with, or considered in connection with, real-time data from any of perception sensors 218 by navigation controller 225 to make informed vision-based navigation decisions. One of these informed vision-based navigation decisions is navigation relative to assets of the UAV delivery service deployed at terminal area 100 (e.g., landing pads, fiducial navigation markers, etc.) or assets deployed at a waypoint pickup location 101.

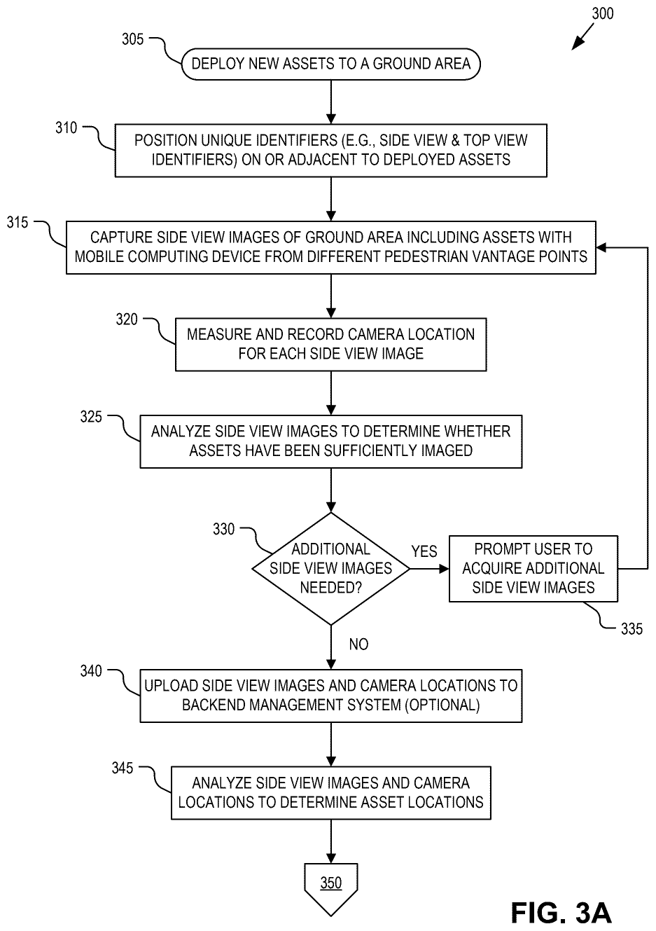

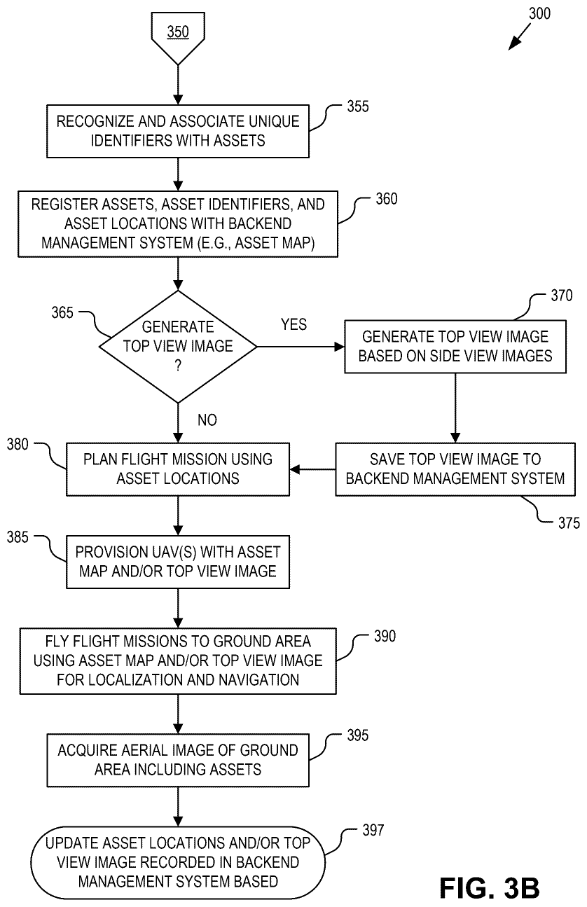

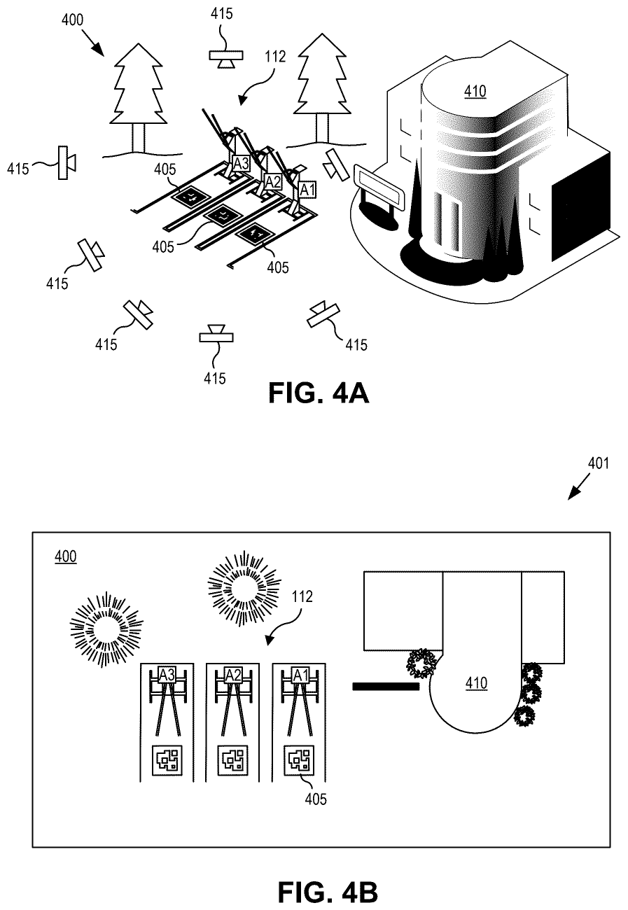

FIGS. 3A & 3B are a flow chart illustrating a process 300 for mapping and registering assets deployed for a UAV service, in accordance with an embodiment of the disclosure. Process 300 is described with reference to FIGS. 2, 4A, and 4B. The order in which some or all of the process blocks appear in process 300 should not be deemed limiting. Rather, one of ordinary skill in the art having the benefit of the present disclosure will understand that some of the process blocks may be executed in a variety of orders not illustrated, or even in parallel.

In a process block 305, one or more assets are newly deployed to a ground area. These assets may include a new autoloader mechanism 112, a new landing pad 113, a new fiducial navigation marker 114, or otherwise. These new assets may be physically positioned at a nest area (e.g., terminal area 100), a waypoint pickup area 101, or otherwise. FIG. 4A illustrates an example ground area 400 including three newly deployed autoloader mechanisms 112 each labeled with a unique identifier A1-A3 and three newly deployed fiducial navigation markers 405. Ground area 400 may represent an example of waypoint pickup location 101 including three autoloader mechanism 112, which provide an aerial delivery service for the adjacent merchant business 410. When deploying the new assets, unique identifiers are positioned on or adjacent to each newly deployed asset (process block 310). The unique identifiers uniquely identify each asset from other assets of the UAV service deployed at the ground area 400. The unique identifiers may even provide, or correlate to, a software reference handle for naming the deployed assets in backend management system 202. In the illustrated embodiment, the unique identifiers should be positioned to be viewable from both pedestrian vantage points and UAV aerial vantage points. In the illustrated embodiment, autoloader mechanisms 112 include both side view instances of unique identifiers A1-A3 (see FIG. 4A) and top view instances of unique identifier A1-A3 (see FIG. 4B). The side view instances are easily viewable in side view images 275 acquired by mobile computing device 201 from one or more pedestrian vantage points 415 and by merchant employees when identifying which autoloader mechanism 112 to load with a particular package for delivery. The top view instances are readily detectable by UAVs 105 when descending to towards ground area 400 to pickup the appropriate package from the correct autoloader mechanism 112 for delivery. Since the fiducial navigation markers are positioned directly on the ground and intended for machine vision, their unique identifiers are machine vision codes (e.g., two-dimensional matrix/bar codes, such as quick-response codes, AprilTag codes, etc.) that are readable from images acquired in the air and from pedestrian vantage points 415. Of course, the unique identifiers for any of the assets may assume a variety of different form factors, formats, codes, human or machine languages, etc. The unique identifiers may be permanently or temporarily disposed on or adjacent to the assets. They may be adhered to, attached to, painted on, or even integrated into the individual assets.

Once the assets are physically positioned and adequately marked with unique identifiers, an on-site human operator captures side view images 275 of ground area 400 including the assets from the different pedestrian vantage points about ground area 400 (process block 315). These side view images 275 may be acquired using application 260 executing on mobile computing device 201. Side view images 275 are generally ground level images captured by a pedestrian carrying mobile computing device 201. Contemporaneous with capturing side view images 275, mobile computing device 201 measures its camera location and records this camera information indexed to each side view image 275 as metadata (process block 320). The camera location metadata records the particular pedestrian vantage point 415 associated with each side view image 275. The camera location may be measured using built-in sensors of mobile computing device 201. For example, an onboard GNSS sensor may be used to acquire its location. In other embodiments, the precision of the camera location output from the GNSS sensor may be improved using WiFi positioning services, onboard IMU sensors that track motion as the human operator walks between different pedestrian vantage points 415, or otherwise.

In a process block 325, side view images 275 are analyzed by application 260 to determine whether all of the assets deployed at ground area 400 have been sufficiently imaged for mapping their locations and/or generating a top view image of the assets as ground area 400. This analyzing may use object recognition software trained to recognize either the assets themselves and/or the unique identifiers disposed on or adjacent to each asset. For each identified asset, the software can then judge whether the identified asset has been imaged from sufficiently different vantage points to map its location at ground area 400 and optionally perform a side-to-top view transformation. A feature matcher, such as SuperGlue, may be interfaced with application 260 to match features across the multiple side view images 275 and aid in the determination of whether sufficient coverage of the scene at ground area 400 has been acquired. In other embodiments, the camera location data may, additionally, be analyzed to determine if the assets have been adequately imaged. If additional side view images are determined by application 260 to be required (decision block 330), then the human operator/user may be prompted (process block 335) to capture additional side view images from one or more additional different pedestrian vantage points until the detected assets are sufficiently imaged.

Once the desired set of side view images 275 has been acquired (decision block 330), the side view images and camera location data may be analyzed to determine asset locations for each of the assets deployed at ground area 400 (process block 345). While in some embodiments this analysis may be executed onboard mobile computing device 201, it is anticipated that side view images 275 along with the camera location data will be uploaded to backend management system 202 (process block 340) for cloud-based computation by logic 265. The asset locations may be computed from side view images 275 and the camera location data using a variety of different techniques. In one embodiment, a three-dimensional (3D) model of ground area 400, including the newly deployed assets, may be generated by a triangulation from projections of the 2D side view images 275. Triangulation refers to a known machine vision process of determining a point in 3D space given projections from two or more 2D images. The location of each 2D image is known from camera locations measured in process block 320. In yet another embodiment, the asset locations may also be determined by using machine learning models trained to determine the relative positions of imaged objects when the pose and location of the source images are known. For example, a neural radiance field (NeRF) model may be trained with side view images 275 to generate a top view image of ground area 400 including the assets. Object recognition software may then analyze the generated top view image to detect the assets and then the camera locations of side view images 275 used to geo-register the top view image and specifically the detected objects therein. Of course, it is expected that other machine vision, 3D modeling, triangulation, or machine learning techniques may be implemented to geo-locate objects included in a set of 2D images acquired from known camera locations/poses.

Once the asset locations are determined, process 300 continues to FIG. 3B via off-page reference 350. In a process block 355, side view images 275 are also analyzed to recognize the unique identifiers disposed on or adjacent to each asset and associate each unique identifier to the imaged asset. In process block 360, the asset locations, unique identifiers, and assets themselves are then registered with backend management system 202. In one embodiment, the assets, asset identifiers, and asset locations are stored in asset maps 270 maintained by backend management system 202. Each asset map 270 may be associated with a given ground area 400, terminal area 100, or waypoint pickup location 101.

In addition to location mapping and asset registration, side view images 275 may be further processed to perform a side-to-top view transformation to generate a top view image 401 of ground area 400 (decision block 365 & process block 370). The above described machine vision triangulation or machine learning models (e.g., NeRF) may be used to generate the top view image 401 from side view images 275. As discussed above, the top view image 401 may also be geo-registered (e.g., image pixels mapped to latitude/longitude positions) based upon the camera locations (e.g., pose data) indexed to each side view image 275. Top view image 401 may then be saved with the corresponding asset map 270 (process block 375). The top view image 401 may also be annotated to identify each asset, which is geo-located and associated with a unique identifier registered with backend management system 202.

Mapping the asset locations of each newly deployed asset and then registering those assets with backend management system 202 enables route planning software of backend management system 202 to use and reference those assets when planning future flight missions (process block 380). Thus, the techniques described herein make deployed assets mission ready in minimal time. The deployed assets can be incorporated into mission planning in short order without performing other more costly, time consuming, and potentially error prone mapping techniques. For example, flight missions may be planned using the asset locations of the new deployed assets prior to those asset locations being mapped via aerial imagery or without direct registration of each of the assets using a GNSS sensor (e.g., taking a separate GPS sensor reading at each asset).

In addition to using asset locations for flight planning, UAVs 105 may be provisioned with asset maps and/or top view images (such as top view image 401) relevant for a given mission (process block 385). These top view images are provisioned into the UAV's asset library as navigation reference images 280. Of course, simplified geo-located asset maps (with or without top view images) may also be provisioned into UAVs 105.

As UAV 105 flies a given flight mission, it may reference its asset maps and/or navigation reference images 280 for localization and navigation as needed (process block 390). When flying over a ground area, such as ground area 400, that has been mapped using the top-to-side view mapping described herein, UAV 105 may acquire real-time aerial images 207 of ground area 400 and compare those images against navigation reference images 280 stored onboard within its asset library. That comparison may include establishing a homography between one of navigation reference images 280 and its real-time aerial images 207 using homography mapping tool 250. Once a homography is established, UAV 105 can localize itself with reference to the geo-located navigation reference image 280. This homography localization may then be used to enable precision navigation decisions over the ground area. Example navigation decisions include identifying which autoloader mechanism 112 is holding a package for delivery, and then navigating into alignment with that autoloader mechanism 112 using one or more of the above described vision-based navigation modules 220. It should be appreciated that the homography based side-to-top view localization techniques described herein may be used generally to localize UAVs 105 anywhere along their flight plan and need not be limited to ground areas that contain assets or objects of an UAV service. Rather, the technique may be used for UAV localization during hover or cruise flight segments based upon UAV service assets, municipal infrastructure (e.g., buildings, roads, sidewalks, signs, utility poles, etc.), or any recognizable object (e.g., vegetation, etc.).

In a scenario where UAV 105 is the first UAV 105 to fly over ground area 400 after a new asset has been deployed, one or more aerial images 207 along with other sensor data (e.g., GNSS location data from GNSS sensor 215) may be captured and uploaded to backend management system 202 to update its associated asset map 270 (process block 397). For example, the asset locations and/or the generated top view image may be updated, refined, or replaced based upon the actual aerial image 207 acquired by the initial UAV flight over ground area 400.

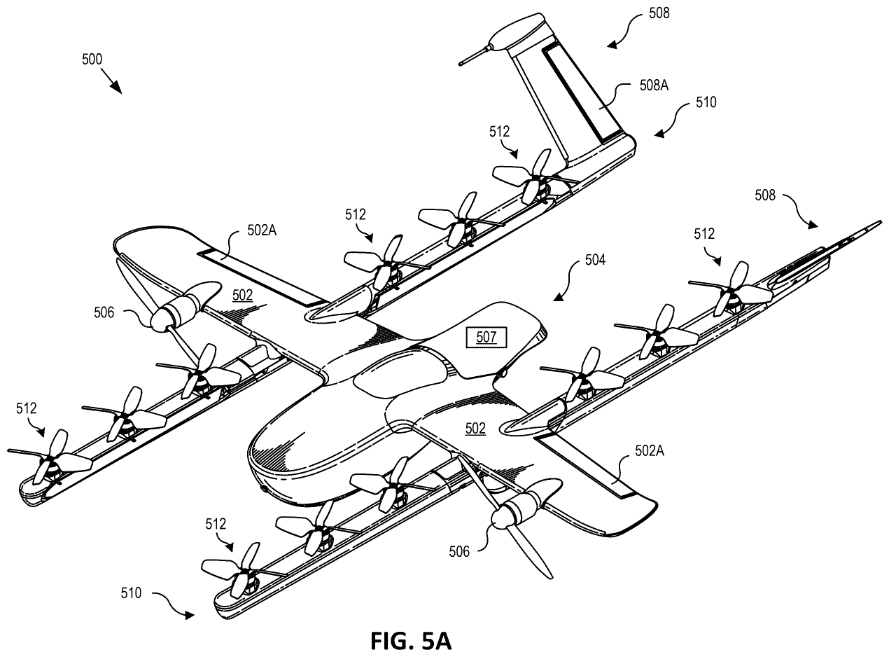

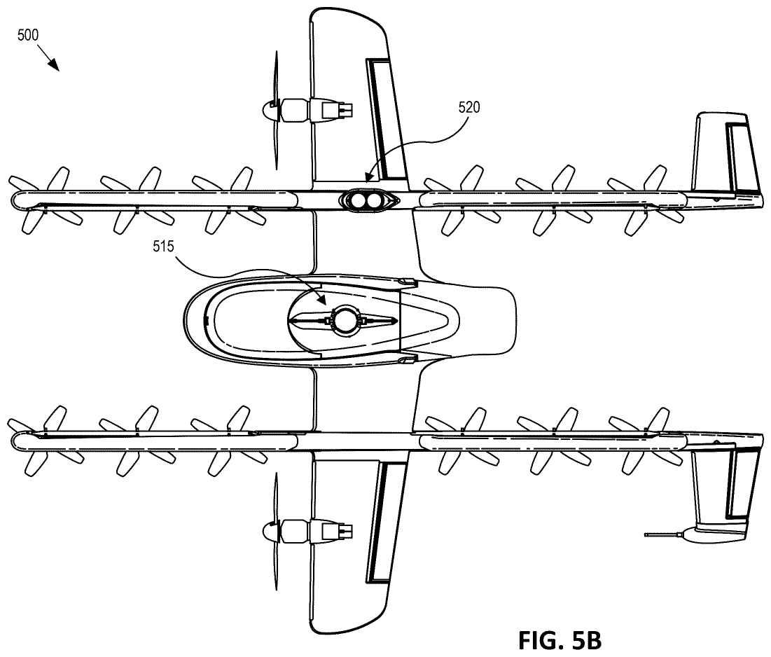

FIGS. 5A and 5B illustrate a UAV 500 that is well-suited for delivery of packages, in accordance with an embodiment of the disclosure. FIG. 5A is a topside perspective view illustration of UAV 500 while FIG. 5B is a bottom side plan view illustration of the same. UAV 500 is one possible implementation of UAVs 105 illustrated in FIG. 1, although other types of UAVs may be implemented for a UAV delivery service as well.

The illustrated embodiment of UAV 500 is a vertical takeoff and landing (VTOL) UAV that includes separate propulsion units 506 and 512 for providing horizontal and vertical propulsion, respectively. UAV 500 is a fixed-wing aerial vehicle, which as the name implies, has a wing assembly 502 that can generate lift based on the wing shape and the vehicle's forward airspeed when propelled horizontally by propulsion units 506. The illustrated embodiment of UAV 500 has an airframe that includes a fuselage 504 and wing assembly 502. In one embodiment, fuselage 504 is modular and includes a battery module, an avionics module, and a mission payload module. These modules are secured together to form the fuselage or main body.

The battery module (e.g., fore portion of fuselage 504) includes a cavity for housing one or more batteries for powering UAV 500. The avionics module (e.g., aft portion of fuselage 504) houses flight control circuitry of UAV 500, which may include a processor and memory, communication electronics and antennas (e.g., cellular transceiver, wifi transceiver, etc.), and various sensors (e.g., GNSS sensor, an inertial measurement unit, a magnetic compass, a radio frequency identifier reader, etc.). Collectively, these functional electronic subsystems for controlling UAV 500, communicating, and sensing the environment may be referred to as a control system 507. The mission payload module (e.g., middle portion of fuselage 504) houses equipment associated with a mission of UAV 500. For example, the mission payload module may include a payload actuator 515 (see FIG. 5B) for holding and releasing an externally attached payload (e.g., package for delivery). In some embodiments, the mission payload module may include camera/sensor equipment (e.g., camera, lenses, radar, lidar, pollution monitoring sensors, weather monitoring sensors, scanners, etc.). In FIG. 5B, an onboard camera 520 (e.g., onboard camera system 205) is mounted to the underside of UAV 500 to support a computer vision system (e.g., stereoscopic machine vision) for visual triangulation and navigation as well as operate as an optical code scanner for reading visual codes affixed to packages. These visual codes may be associated with or otherwise match to delivery missions and provide the UAV with a handle for accessing destination, delivery, and package validation information. Of course, onboard camera 520 may alternatively be integrated within fuselage 504.

As illustrated, UAV 500 includes horizontal propulsion units 506 positioned on wing assembly 502 for propelling UAV 500 horizontally. UAV 500 further includes two boom assemblies 510 that secure to wing assembly 502. Vertical propulsion units 512 are mounted to boom assemblies 510 and provide vertical propulsion. Vertical propulsion units 512 may be used during a hover mode where UAV 500 is descending (e.g., to a delivery zone), ascending (e.g., at initial launch or following a delivery), or maintaining a constant altitude. Stabilizers 508 (or tails) may be included with UAV 500 to control pitch and stabilize the aerial vehicle's yaw (left or right turns) during cruise. In some embodiments, during cruise mode vertical propulsion units 512 are disabled or powered low and during hover mode horizontal propulsion units 506 are disabled or powered low.

During flight, UAV 500 may control the direction and/or speed of its movement by controlling its pitch, roll, yaw, and/or altitude. Thrust from horizontal propulsion units 506 is used to control air speed. For example, the stabilizers 508 may include one or more rudders 508A for controlling the aerial vehicle's yaw, and wing assembly 502 may include elevators for controlling the aerial vehicle's pitch and/or ailerons 502A for controlling the aerial vehicle's roll. Rudders 508A and ailerons 502A are referred to as control surfaces. While the techniques described herein are particularly well-suited for VTOLs providing an aerial delivery service, it should be appreciated that the techniques described herein are generally applicable to a variety of aircraft types (not limited to VTOLs) providing a variety of services or serving a variety of functions beyond package deliveries.

Many variations on the illustrated fixed-wing aerial vehicle are possible. For instance, aerial vehicles with more wings (e.g., an “x-wing” configuration with four wings), are also possible. Although FIGS. 5A and 5B illustrate one wing assembly 502, two boom assemblies 510, two horizontal propulsion units 506, and six vertical propulsion units 512 per boom assembly 510, it should be appreciated that other variants of UAV 500 may be implemented with more or less of these components.

It should be understood that references herein to an “unmanned” aerial vehicle or UAV can apply equally to autonomous and semi-autonomous aerial vehicles. In a fully autonomous implementation, all functionality of the aerial vehicle is automated; e.g., pre-programmed or controlled via real-time computer functionality that responds to input from various sensors and/or pre-determined information. In a semi-autonomous implementation, some functions of an aerial vehicle may be controlled by a human operator, while other functions are carried out autonomously. Further, in some embodiments, a UAV may be configured to allow a remote operator to take over functions that can otherwise be controlled autonomously by the UAV. Yet further, a given type of function may be controlled remotely at one level of abstraction and performed autonomously at another level of abstraction. For example, a remote operator may control high level navigation decisions for a UAV, such as specifying that the UAV should travel from one location to another (e.g., from a warehouse in a suburban area to a delivery address in a nearby city), while the UAV's navigation system autonomously controls more fine-grained navigation decisions, such as the specific route to take between the two locations, specific flight controls to achieve the route and avoid obstacles while navigating the route, and so on.

The processes explained above are described in terms of computer software and hardware. The techniques described may constitute machine-executable instructions embodied within a tangible or non-transitory machine (e.g., computer) readable storage medium, that when executed by a machine will cause the machine to perform the operations described. Additionally, the processes may be embodied within hardware, such as an application specific integrated circuit (“ASIC”) or otherwise.

A tangible machine-readable storage medium includes any mechanism that provides (i.e., stores) information in a non-transitory form accessible by a machine (e.g., a computer, network device, personal digital assistant, manufacturing tool, any device with a set of one or more processors, etc.). For example, a machine-readable storage medium includes recordable/non-recordable media (e.g., read only memory (ROM), random access memory (RAM), magnetic disk storage media, optical storage media, flash memory devices, etc.).

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. A method of mapping assets deployed for an unmanned aerial vehicle (UAV) service, the method comprising:
capturing, with a mobile computing device, a plurality of side view images of a ground area including the assets, the assets deployed to the ground area for supporting operations of the UAV service, the side view images acquired from different pedestrian vantage points about the ground area;
measuring, by the mobile computing device, camera locations of the mobile computing device when capturing the side view images;
analyzing the side view images along with the camera locations of the mobile computing device to determine asset locations of the assets at the ground area; and
updating a backend management system of the UAV service to record the asset locations determined from the analyzing.

2. The method of claim 1, further comprising:
planning a flight mission of the UAV service using the asset locations determined from the analyzing prior to the asset locations being mapped via aerial imagery or without direct registration of each of the assets using a global navigation satellite system (GNSS) sensor.

3. The method of claim 2, further comprising:
flying the flight mission with a UAV of the UAV service;
acquiring an aerial image of the ground area including the assets; and
updating the asset locations recorded in the backend management system based on the aerial image.

4. The method of claim 1, wherein the assets include unique identifiers disposed thereon or adjacent thereto, wherein the unique identifiers are each positioned to be identifiable from at least one of the different pedestrian vantage points, the method further comprising:
recognizing each of the unique identifiers captured in the side view images; and
registering, in the backend management system, each of the assets with an associated one of the unique identifiers and an associated one of the asset locations.

5. The method of claim 4, wherein the unique identifiers comprise side view identifiers oriented to be viewable by pedestrians and wherein the assets further include top view identifiers corresponding to the side view identifiers, the top view identifiers oriented to be viewable by UAVs from above.

6. The method of claim 4, wherein the UAV service comprises a UAV delivery service, and wherein:
the ground area comprises a UAV nest area and the assets include landing pads deployed at the UAV nest area adapted for staging and charging UAVs of the UAV delivery service, or
the ground area comprises a waypoint pickup location and the assets include an autoloader mechanism adapted for transferring packages to the UAVs.

7. The method of claim 1, further comprising:
generating a top view image of the ground area including the assets based upon the analyzing of the side view images;
provisioning a UAV of the UAV service having a flight plan that flies to or over the ground area with a navigation reference image that is based upon the top view image;
comparing real-time aerial images acquired by the UAV when flying above the ground area to the navigation reference image; and
localizing the UAV relative to the ground area based upon the comparing.

8. The method of claim 1, further comprising:
performing object recognition on the assets in the side view images;
analyzing the side view images using a feature matcher to determine if each of the assets recognized in the side view images has been sufficiently imaged from the different pedestrian vantage points to generate a top view image of the ground area including the assets; and
prompting a user of the mobile computing device to capture additional side view images from one or more additional different pedestrian vantage points if one or more of the assets is determined to be insufficiently imaged.

9. The method of claim 1, wherein the side view images comprise two-dimensional (2D) side view images and wherein analyzing the side view images along with the camera locations of the mobile computing device to determine the asset locations of the assets at the ground area comprises:
generating a three-dimensional (3D) model of the ground area including the assets by a triangulation from projections of the 2D side view images.

10. The method of claim 1, wherein analyzing the side view images along with the camera locations of the mobile computing device to determine the asset locations of the assets at the ground area comprises:
training a neural radiance field (NeRF) model with the side view images to generate a top view image of the ground area; and
using the camera locations of the side view images to geo-register the top view image output from the NeRF model.

11. At least one machine-readable storage medium storing instructions that, when executed by unmanned aircraft systems (UAS), will cause the UAS to map objects by performing operations comprising:
capturing, with a mobile computing device, a plurality of side view images of a ground area including the objects, the side view images acquired from different pedestrian vantage points about the ground area;
measuring, by the mobile computing device, camera locations of the mobile computing device when capturing the side view images;
analyzing the side view images along with the camera locations of the mobile computing device to determine object locations of the objects at the ground area; and
updating a backend management system of the UAS to record the object locations determined from the analyzing.

12. The at least one machine-readable storage medium of claim 11, wherein the objects comprise assets deployed to the ground area for supporting operations of the UAS and wherein the object locations comprise asset locations.

13. The at least one machine-readable storage medium of claim 12, wherein the operations further comprise:
planning a flight mission of the UAS using the asset locations determined from the analyzing prior to the asset locations being mapped via aerial imagery or without direct registration of each of the assets using a global navigation satellite system (GNSS) sensor.

14. The at least one machine-readable storage medium of claim 13, wherein the operations further comprise:
flying the flight mission with a UAV of the UAS;
acquiring an aerial image of the ground area including the assets; and
updating the asset locations recorded in the backend management system based on the aerial image.

15. The at least one machine-readable storage medium of claim 12, wherein the assets include unique identifiers disposed thereon or adjacent thereto, wherein the unique identifiers are each positioned to be identifiable from at least one of the different pedestrian vantage points, the method further comprising:
recognizing each of the unique identifiers captured in the side view images; and
registering, in the backend management system, each of the assets with an associated one of the unique identifiers and an associated one of the asset locations.

16. The at least one machine-readable storage medium of claim 15, wherein the unique identifiers comprise side view identifiers oriented to be viewable by pedestrians and wherein the assets further include top view identifiers corresponding to the side view identifiers, the top view identifiers oriented to be viewable by UAVs from above.

17. The at least one machine-readable storage medium of claim 15, wherein the UAS comprise a UAV delivery service, and wherein:
the ground area comprises a UAV nest area and the assets include landing pads deployed at the UAV nest area adapted for staging and charging UAVs of the UAV delivery service, or
the ground area comprises a waypoint pickup location and the assets include an autoloader mechanism adapted for transferring packages to the UAVs.

18. The at least one machine-readable storage medium of claim 11, wherein the operations further comprise:
generating a top view image of the ground area including the objects based upon the analyzing of the side view images;
provisioning a UAV of the UAS having a flight plan that flies to or over the ground area with a navigation reference image that is based upon the top view image;
comparing real-time aerial images acquired by the UAV when flying above the ground area to the navigation reference image; and
localizing the UAV relative to the ground area based upon the comparing.

19. The at least one machine-readable storage medium of claim 11, wherein the operations further comprise:
performing object recognition on the objects in the side view images;
analyzing the side view images using a feature matcher to determine if each of the objects recognized in the side view images has been sufficiently imaged from the different pedestrian vantage points to generate a top view image of the ground area including the objects; and
prompting a user of the mobile computing device to capture additional side view images from one or more additional different pedestrian vantage points if one or more of the objects is determined to be insufficiently imaged.

20. The at least one machine-readable storage medium of claim 11, wherein the side view images comprise two-dimensional (2D) side view images and wherein analyzing the side view images along with the camera locations of the mobile computing device to determine the object locations of the objects at the ground area comprises:
generating a three-dimensional (3D) model of the ground area including the objects by a triangulation from projections of the 2D side view images.

21. The at least one machine-readable storage medium of claim 11, wherein analyzing the side view images along with the camera locations of the mobile computing device to determine the object locations of the objects at the ground area comprises:
training a neural radiance field (NeRF) model with the side view images to generate a top view image of the ground area; and
using the camera locations of the side view images to geo-register the top view image output from the NeRF model.
